(19) United States
(12) Patent Application Publication
(10) Pub. No.: US 2005/0117165 A1
(43) Pub. Date: Jun. 2, 2005

(54) Semiconductor etching process control

(75) Inventors: Mark Holbrook, Kilmarnock (GB); David Heason, Glasgow (GB); David Reeve, Chapel Hill (AU); Michael S Boger, Santa Clara, CA (US); Florian L'Hostis, Wanaka (NZ)

Correspondence Address: David S Resnick;NIXON PEABODY LLP, 100 Summer Road, Boston, MA, 02110, US

(73) Assignee: The BOC Group, Inc., Murray Hill, NJ (US)

(21) Appl. No.: 10/508,438

(22) PCT Filed: Mar. 18, 2003
(86) PCT No.: PCT/US03/08389

(30) Foreign Application Priority Data
Mar. 18, 2002 (GB) 0206342.8

(51) Int. Cl. G01B 11/02

(52) U.S. Cl. 356/504

(57) ABSTRACT

The thickness of a silicon wafer (3) within a processing vacuum enclosure (1) is measured or monitored by an optical apparatus (50) via a window (4). The optical apparatus (5) comprises a laser which is tuneable across a range of wavelengths while maintaining a narrow bandwidth. The optical apparatus (5) also includes a detector receiving reflected light. The wavelength variation produces interference effects which are used, by examination of the detector output, to give a measure of thickness or other parameters.

The present invention relates to a method and apparatus for the inspection or monitoring of thin films, and to improved process control using the same in the production of thin film articles such as integrated circuits.

Wavelength scanning interferometry is a known technique, in which a sample is examined using a light beam whose wavelength is scanned across a range of wavelengths. In the prior art, however, light sources have been used which are wide-band and relatively broad in line width. This has meant that long signal processing times have been required, and wavelength scanning interferometry has not been suitable for use in on-line process control.

It is well known that monochromatic light impinging upon the smooth surface of a material which is substantially transparent at the wavelength of such light, where either a) the back surface of said material is also smooth and substantially parallel to the front, or b) internal structures that present steps in refractive index are present, a multiplicity of reflected beams will arise and constructive and destructive interference will occur between them. Where the thickness of the material intervening the various points of reflection remains fixed, and the wavelength of said monochromatic light is varied over a range of values, and the coherence length of the source is greater than or equal to the optical path length difference between the various reflection points, then the combination of the multiplicity of beams will move from constructive to destructive interference and back as the wavelength of the monochromatic light source changes. By monitoring the intensity of the combined beam as it changes with the wavelength of the source, it is possible to determine the thickness of the layers that separate the various sources of reflection. Furthermore, by considering the imaginary component of the refractive index of the various components of the material, it is possible to deduce chemical composition of some of those components.

It is well known that under certain specific conditions the control of processes for etching materials from a surface or, alternatively, depositing material on that surface, can be conveniently arranged by a means that follows the variation in intensity over time of a beam of monochromatic light reflected from said surface. Ref: FR-2718231).

The necessary conditions for such a means to function are:
That the surface undergoing etching or deposition provides, in combination with the lower surface or the intervening layered structures, a multiplicity of reflected beams, with each source of reflection separated from each of the others by a distance that is less than or equal to the coherence length of the illuminating source; “coherence length” referring to the coherent nature of the source and being related to the reciprocal of the line width.
That the reflecting surfaces and or internal layer interfaces are smooth and do not scatter more than a small percentage (less than 5%) of the light incident upon them.
That the reflecting surfaces and or internal layer interfaces are flat to better than 1/10 of the wavelength of the illuminating light over the area illuminated.
That the absorption by the material at the surface and at all underlying structures at the wavelength of the illuminating light is small (less than 10%).

If the reflection signal is tracked as material is etched from or deposited onto the surface, then processing that signal with filters derived from a mathematical model that simulates reflection from such a surface will provide for real-time process control of thickness etched or deposited. (Ref: U.S. 6,226,086 B1)

The above method is applicable only to those instances where the thickness of the measured system varies by agency of either a deposition or etch process. It is limited to determination of one physical parameter, the thickness of the changing layer, the values of the other parameters having been input as pre-assumed values into the mathematical model.

In conventional semiconductor (e.g. silicon) etch processes, a special layer is deposited which is later used as an etch-stop. A subsequent layer is then deposited, which later will be etched down to this special layer. The etch process is a combination of chemical and physical processes whereby the layer of interest is etched. The end point of the etch normally relies on a change in the chemical conditions in the plasma when the etched material is sufficiently eroded, exposing the etch-stop material. The etch chemicals react slower and with slightly different chemistry with the etch-stop material. This change is detected using a variety of methods.

It would be beneficial to eliminate the entire process step used to deposit the etch stop layer. If an entire process deposition step (and associated clean up steps) are removed, wafer throughput could be increased as well as making a small positive impact on wafer yield. In addition the inclusion of the etch stop layer is often detrimental to the performance of the completed semiconductor device which would have had a superior performance if the etch stop layer had not been included.

It is an objective of the current invention to improve on this prior art.

Embodiments of the invention may provide one or more of the following advantages:
Measurement when the thickness of the measured system of films is not varying.
Measurement of more than one parameter. For example, without prejudice to the generality of this method, it would be possible to determine the thicknesses of several layers in a multilayer stack, or the thickness and chemical composition of a given layer.
Man increase in speed and accuracy of mathematical manipulation of data so that the invention may be used in real-time applications as opposed to off-line use.
Measurement to detect etch endpoint without the use of an etch stop layer even if the criteria for the endpoint is the remaining thickness of a layer of the same composition which has up to that point already been etched.

Accordingly, the present invention provides a method for inspection or measurement of thin films, in which the film is illuminated with a light beam, the wavelength of which is selected to be one at which the layer of interest is not absorbing, said wavelength is scanned through a range of wavelengths, and the intensity variation of the reflected beam is measured; and in which the light beam is derived from a light source of very narrow line width, the accuracy of the wavelength is maintained within tightly defined limits, and the wavelength is tuned across the desired range to derive a data set of reflection level and wavelength.

From another aspect the invention provides a method of etching a wafer, comprising positioning the wafer within a vacuum enclosure, measuring the initial thickness of a desired point on the wafer by the method of the preceding paragraph, initiating an etching process, monitoring the thickness of said desired point by the method of the preceding paragraph as the etching progresses, and terminating etching when a desired thickness is reached.

From a further aspect the invention provides apparatus for inspection or measurement of thin films, comprising a tuneable narrow band light source with a width of wavelength, which light source can be tuned across a range of wavelengths while maintaining a narrow line width, and an optical assembly for focussing the laser spot on the film structure to be inspected and for transmitting reflected light to an optical sensor.

Other features and advantages of the present invention will be apparent from the claims and from the following description, given by way of example only, of embodiments of the invention.

In the drawings:

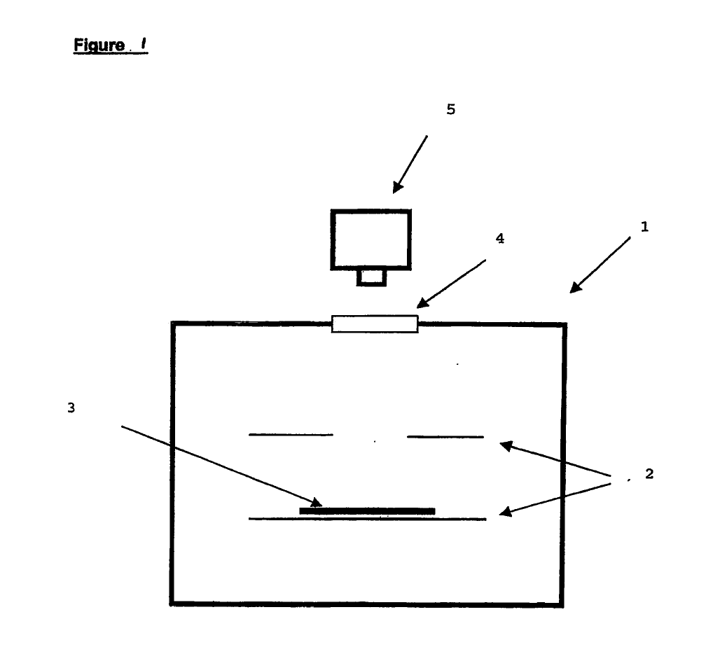

FIG. 1 is a schematic cross-sectional view of a vacuum processing system used in the production of integrated circuits;

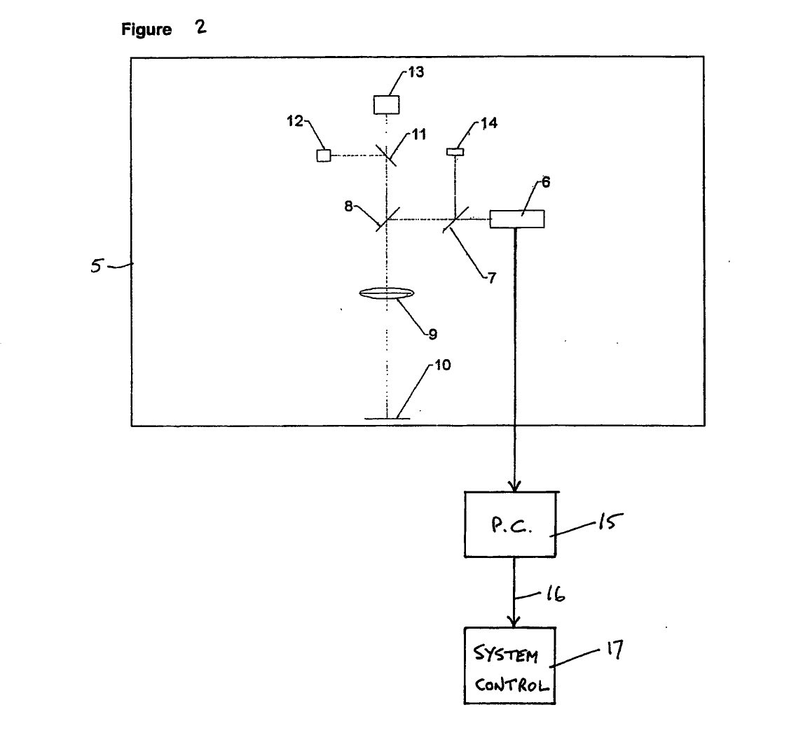

FIG. 2 is a diagrammatic representation showing in more detail an optical apparatus used in the system of FIG. 1.

FIG. 1 shows atypical vacuum processing vessel 1 containing two electrodes 2 for the generation of an electric field and in which a substrate 3 to be etched is placed on the grounded electrode. A plasma is then produced between the electrodes 2 and a reagent gas introduced. The plasma dissociates the gas into the ions and radicals which bring about the etching of the substrate 3. A window 4 is provided in the vessel 1, through which a laser beam is projected and the return beam received by an optical apparatus 5.

FIG. 2 shows, in diagrammatic form, the makeup of the optical apparatus.

An optical window 10 provides for the passage of light into and out of the optical assembly 5. A lens 9 provides for focussing the probe light on to the film structure being measured and, at the same time, for relay of an image of that focussed spot and the adjacent surface on to an imaging means 13. An additional illumination source 12 may be provided and introduced into the optical path by a beamsplitter 11 so that the adjacent surface may be readily detected by the imaging means 13 under circumstances of low ambient illumination.

A laser 6 is provided having a wavelength that is substantially not absorbed by the film structure being measured. Without loss of generality, the film structure may be a silicon wafer with both surfaces polished and a starting thickness of 0.6 mm. Under those circumstances the laser 6 may be chosen to have a centre wavelength of 1550 nm, a wavelength accuracy of +/−40 picometres, a linewidth of less than 10 pico metres and a tuneable range of 100 nm. In general terms, the range of tuning should be such as to provide at least two turning points (maximum or minimum) as the wavelength is tuned across the range.

The laser is an Indium Phosphide semiconductor laser device operating in a single mode of operation and constrained to a particular wavelength by providing external reflectance and wavelength selection means with provision to smoothly and continuously adjust the same so that the centre wavelength of illumination has a full width at half maximum of 10 pico metres or less. Such lasers are commercially available.

Radiation from the laser 6 is introduced into the optical path of the imaging means 13 by a beamsplitter 8. After transmission to the substrate with its film system to be measured, the returned radiation passes again to the beamsplitter 8 and part of the radiation then passes to a further beamsplitter 7 and is directed on to a detector 14. The detector 14 may be conveniently a high speed Gallium Indium Arsenide photodiode.

Part of the illumination originating from the laser 6 after reflection from the film system to be measured proceeds through the beamsplitter 8 to form part of the image detected by imaging means 13.

The measurement is made by varying the wavelength of the laser 6 and at the same time recording the signal from the detector 14. This data set is then input to a genetic algorithm means which may be conveniently implemented on a personal computer 15. An additional input to the genetic algorithm means is a prediction of the boundary conditions of the film system that is being measured, this may be understood as there is a priori knowledge that the film system parameters fall within these defined boundaries.

The function of the genetic algorithm means is then to produce candidate solutions by reference to the mathematical description of the material structure under analysis. These candidate solutions are scored relative to their closeness of behaviour to the data set obtained. The offspring candidates from those solutions which are close to the data set survive, the offspring candidates from those solutions which are further from the data set fail. In this way, by mathematically mimicking the principles of natural selection a prime candidate is quickly and conveniently found. The parameters of the film system to be measured that arise from this efficient and convenient genetic algorithm processing means are then conveyed by a data link 16 to a system control computer 17 thus providing a means of on-line process control.

In one example of a suitable genetic algorithm, the algorithm employs a three-gene chromosome of which a first gene maps to the thickness of the thin film being measured or inspected, a second gene acts as a multiplier for the reflectance signal. and the third gene acts as an offset modifier for the reflectance signal. This may be used to match the measured reflectance data set to that predicted by a mathematical model of a single layer film of uniform and predetermined refractive index, the reflectance signal arising from a combination of the reflections from its upper and lower surfaces.

Alternatively, this algorithm may be used to match the measured reflectance data set to that predicted by a mathematical model of a multi-layer structure, the outermost layer of which is of a uniform and predetermined refractive index and forms the layer whose thickness is to be measured, the measured reflectance signal being a combination of that arising from any of the boundaries between layers in addition to that arising from the upper surface of the structure, and which may be need not include the contribution from the bottom surface.

This algorithm may also be used in the case where the layer to be measured does not have a uniform refractive index, but exhibits a known gradient in refractive index which can be used in the mathematical model.

In another example, the genetic algorithm uses a three-gene chromosome in which a first gene maps to the thickness of the thin film being measured or inspected, a second gene maps to the refractive index of this film, and the third gene acts as an offset modifier for the reflectance signal.

Using either form of algorithm it is possible to ascertain the thickness of a single film, or of the outermost layer of a multilayer structure, in the absence of a priori knowledge of its refractive index.

The foregoing apparatus and method can be used to control etching of thin films without use of an etch stop layer. The light dot is focused on an exposed surface of the silicon wafer to be etched. The laser wavelength is adjusted and the resulting interference pattern is analysed to determine the thickness of the material. Etching then takes place, during which the interference pattern will shift. The etching is stopped when the detected thickness corresponds to the original thickness less the desired etch.

It will be understood that modifications may be made to the foregoing specific examples within the scope of the invention.

The invention may be applied to the processing of materials other than silicon, especially semiconductor material such as gallium-arsenide, silicon-germanium, germanium, indium phosphide. More than one chemical may be involved in the etching process, including inert materials. The algorithm may be implemented on any suitable device other than a personal computer, such as a microcontroller or other embedded computing system.

It will be appreciated that the invention may be applied to the measurement of non-varying structures, and to deposition as well as etching. It may be applied to forms of etching other than with chemical vapours, for example ion beam etching, and to chemical-mechanical polishing using slurries and purely mechanical polishing.

1. A method for inspection or measurement of thin films, in which the film is illuminated with a light beam, the wavelength of which is selected to be one at which the layer of interest is not absorbing, said wavelength is scanned through a range of wavelengths, and the intensity variation of the reflected beam is measured; and in which the light beam is derived from a light source of very narrow line width, the accuracy of the wavelength is maintained within tightly defined limits, and the wavelength is tuned across the desired range to derive a data set of reflection level and wavelength.

2. The method of claim 1, in which said light beam has a line width at any point in time of less than or equal to 10 pico metres.

3. The method of claim 1 in which said limits of accuracy are +/−40 picometres of the desired centre wavelength across the range.

4. The method of claim 1, in which the range is such as to provide at least one interference maximum and minimum as the wavelength is tuned across the range.

5. The method of claim 4, in which the range is such as to provide two interference maxima and one minimum, or two interference minima and one maximum.

6. The method according to claim 1, in which the wavelength across the range is chosen such that less than 10% of the light is absorbed by the material being measured.

7. The method of claim 1, in which the measured intensity is processed by providing a mathematical description of the film system being measured, said mathematical description defining boundaries of physical and chemical variation within which the system is known to fall at the time of measurement.

8. The method of claim 7, including determining a preferred match of potential solutions within said boundaries to said data set by applying a genetic algorithm.

9. The method of claim 8 in which the genetic algorithm employs a three gene chromosome.

10. The method of claim 9 in which a first gene maps to the thickness of the film being inspected or measured, a second gene acts as a multiplier for the reflectance signal, and the third gene acts as an offset modifier for the reflectance signal.

11. The method of claim 9, in which a first gene maps to the thickness of the thin film being inspected or measured, a second gene maps to the refractive index of said film, and the third gene acts as an offset modifier for the reflectance signal.

12. The method of claim 8, in which the preferred solution is used as the input to a real-time process control.

13. The method of claim 12, in which the process to be controlled is one in which the measured film structure is varied by a process selected from dry plasma etch, ion bombardment etch, film growth by physical vapor deposition, material removal by chemical mechanical polishing, and material removal by mechanical polishing.

14. A method of etching a wafer, comprising positioning the wafer within a vacuum enclosure, measuring the initial thickness of a desired point on the wafer by the method of claim 1, initiating an etching process, monitoring the thickness of said desired point by the method of claim 1 as the etching progresses, and terminating etching when a desired thickness is reached.

15. The method of claim 14, in which the wafer has one or more areas to be etched which are not provided with a chemically distinct etch stop layer.

16. The method of claim 1 in which the light source is derived from a Indium Phosphide semiconductor laser device operating in a single mode of operation and constrained to a particular wavelength by providing external reflectance and wavelength selection means with provision to smoothly and continuously adjust the same, the centre wavelength of illumination having a full width at half maximum of 10 pico metres or less.

17. Apparatus for inspection or measurement of thin films, comprising a tuneable narrow band light source with a width of wavelength, which light source can be tuned across a range of wavelengths while maintaining a narrow line width, and an optical assembly for focussing the laser spot on the film structure to be inspected and for transmitting reflected light to an optical sensor.

18. Apparatus according to claim 17, in which the width of wavelength at any point in time is less than or equal to 10 pico metres.

19. Apparatus according to claim 17, in which said light source is a single mode laser.

20. Apparatus according to claim 19, in which the laser wavelength has an accuracy of+/−40 picometres of the desired centre wavelength across said range.

21. Apparatus according to claim 17, in combination with computing means connected to receive the output of the optical sensor, the computer means being operable to process the sensor output by use of a genetic algorithm.

22. A material processing system which comprises a vacuum enclosure, means within the enclosure for performing etching or deposition on a wafer positioned in the chamber, and apparatus in accordance with claim 17; the apparatus being positioned exteriorly of the enclosure with said laser beam and reflection passing via a window in the enclosure wall.
